(19) United States
(12) Patent Application Publication
(10) Pub. No.: US 2005/0141768 A1
(43) Pub. Date: Jun. 30, 2005

(54) Video encoding method and corresponding device and signal

(75) Inventors: Cecile Dufour, Paris (FR); Gwenaelle Marquant, Liffre (FR); Stephane Valente, Paris (FR)

Correspondence Address: PHILIPS INTELLECTUAL PROPERTY & STANDARDS, P.O. BOX 3001, BRIARCLIFF MANOR, NY, 10510, US

(73) Assignee: Koninklijka Philips Electronics N.V.

(21) Appl. No.: 10/509,237

(22) PCT Filed: Mar. 19, 2003
(86) PCT No.: PCT/IB03/01040

(30) Foreign Application Priority Data
Mar. 29, 2002 (EP) 02290801.6

(51) Int. Cl. G06K 9/50

(52) U.S. Cl. 382/196

(57) ABSTRACT

The invention relates to an encoding method applied to a video sequence corresponding to successive scenes and generating a coded bitstream in which each data item is described by means of a bitstream syntax allowing, at the decoding side, to recognize and decode all the elements of the content of this coded bitstream. According to the invention, said syntax comprises specific information indicating at a high description level in said bitstream the presence, or not, of various additional channels that can be encountered to describe the content of said bitstream. Several examples of specific information are given.

The present invention relates to the field of video compression and, for instance, to the video coding standards of the MPEG family (MPEG-1, MPEG-2, MPEG-4) and the ITU-H.26X family (H.261, H.263 and extensions, H.26L). More specifically, this invention concerns an encoding method applied to a video sequence corresponding to successive scenes subdivided into successive video object planes (VOPs) and generating, for coding all the video objects of said scenes, a coded bitstream constituted of encoded video data in which each data item is described by means of a bitstream syntax allowing to recognize and decode all the elements of the content of said bitstream, said content being described in terms of separate channels.

The invention also relates to a corresponding encoding device, to a transmittable video signal consisting of a coded bitstream generated by such an encoding device, and to a device for receiving and decoding a video signal consisting of such a coded bitstream.

In the first video coding standards (up to MPEG-2 and H.263), the video was assumed to be rectangular and to be described in terms of a luminance channel and two chrominance channels. With MPEG-4, other channels have been introduced: the alpha channel (also referred to as the “arbitrary shape channel” in MPEG-4 terminology), for describing the contours of the video objects, and, in a later version of MPEG-4, additional channels enabling the transmission of contents like depth, disparity or transparency. The depth channel, for instance, can be used for the applications where navigation in 3D is enabled. The disparity channel is used for the applications for which two views of the content are required, so that said content can be displayed on a device enabling stereoscopic viewing. The transparency channel is required for contents composed of different objects which may be superimposed (a transparency channel for an object may be opaque, and the object texture then overwrites the texture of the other objects, or half-transparent, the texture on the display then resulting from the blending of the texture of the objects).

As defined in the MPEG-4 document w3056, “Information Technology—Coding of audio-visual objects—Part 2: Visual”, ISO/IEC/JTC1/SC29/WG11, Maui, USA, December 1999, part 6.2.3 Video Object Layer, the only way (in MPEG-4) to describe the additional channels like transparency or disparity or depth of a sequence is the use of the syntactic element “Video_object_layer_shape_extension”. The syntax and the semantic provided by MPEG4 in order to support the coding of additional channels via said element are given in pp. 35-36 and 110-112 of the document w3056:
(a) “video_object_layer_verid”: this 4-bit code, defined in table 6-11, identifies the version number of the video object layer;
(b) “video_object_layer_shape”: this 2-bit code, defined in table 6-14, identifies the shape type of a video object layer;
(c) “video_object_layer_shape_extension”: this 4-bit code, defined in table V2-1, identifies the number (up to 3) and type of auxiliary components that can be used (only a limited number of types and combinations are defined in said table, and more applications are possible by selection of the USER DEFINED type).

These syntax and semantic show that the support for the transmission of additional channels is only provided for objects having a shape. In case one wants to transmit the luminance and chrominance channels and one additional channel like the disparity of a rectangular object, it can indeed be explained how MPEG-4 is suboptimal in terms of coding efficiency. In MPEG-4, the description of a rectangular object (knowing that it is really rectangular since the code “video_object_layer_shape” is then equal to 00) requires to transmit the size of the rectangle in terms of width and height. This description, which is given in the Video Object Layer syntax (see the six lines 25 to 30 of p. 36 of the document), requires 31 bits. When one wants to transmit additional channels like the depth channel or the disparity channel of a rectangular object with the MPEG-4 syntax, there is no other means than to declare this object as non rectangular by setting the code “video_object_layer_shape” to 11 (greyscale).

Once the object has been declared as being greyscale (although it is rectangular), the syntax forces to send bits describing the shape of the object, which is done at the macroblock level according to the syntax given in the document, p. 52, § 6.2.6 Macroblock, lines 1 to 6 of the table, and p. 56, § 6.2.6.1 MB Binary Shape Coding, lines 1 to 5 of the table. As indicated in pp. 128-129 of the document, bab_type is a variable length code comprised between 1 and 7 bits and provided for indicating the coding mode used for the binary alpha block of 16×16 pixels, and the seven bab_types are depicted in table 6-26. Such a description leads, for CIF pictures for instance, to a waste of bits at least 396 bits per frame (at least one bit per macroblock). For a 25 Hz CIF sequence, the overhead is estimated at 9.9 kbits/s.

It is therefore an object of the invention to propose a video coding method allowing to avoid this waste of bits and therefore to improve the coding efficiency.

To this end, the invention relates to a method such as defined in the introductory part of the description and which is moreover characterized in that said syntax comprises specific information indicating at a high description level in the bitstream the presence, or not, of the various channels that can be encountered to describe the content of the bitstream.

Preferably, said specific information consists of the following additional syntactic elements:

| | |
|---|---|
| video_object_layer_shape: | 1 bit |
| number_of_video_object_layer_additional_{—} | n bits |
| channel_descriptions: | |
| video_object_layer_additional_channels [i] | 1 bit |

the first element indicating the presence, or not, of a contour or shape channel that should then be decoded, the second one representing the number of additional channel syntax elements present in the coded bitstream in order to describe the content of said bitstream, and the third one identifying the presence, or not, of the channel addressed by the value [i], i taking a value between 0 and 2ⁿ−1.

In another embodiment of the invention, said specific information consists of the following additional syntactic elements:

| | |
|---|---|
| video_object_layer_shape: | 1 bit |
| number_of_video_object_layer_additional_channel_presence: | n bits |
| video_object_layer_additional_channels [i] | 1 bit |

the first element indicating the presence, or not, of a contour or shape channel that should then be decoded, the second one representing the number of additional channels present in the coded bitstream, and the third one identifying the presence, or not, of the channel addressed by the value [i], i taking a value between 0 and 2ⁿ−1.

In a third embodiment, said specific information consists of the following additional syntactic elements:

| | |
|---|---|
| video_object_layer_shape: | 1 bit |
| video_object_layer_additional_channels [i] | 1 bit, 0 <= i <= 2ⁿ − 1 |

the first element indicating the presence, or not, of a contour or shape channel that should then be decoded, and the second one identifying the presence, or not, of the channel addressed by the value [i], i taking a value between 0 and 2ⁿ−1.

With anyone of these three solutions, the video_object_layer_shape syntax element may be no longer provided in the bitstream.

The invention also relates to a device for encoding a video sequence corresponding to successive scenes subdivided into successive video object planes (VOPs), said device comprising means for structuring each scene of said sequence as a composition of video objects (VOs), means for coding the shape, the motion and the texture of each of said VOs, and means for multiplexing the coded elementary streams thus obtained into a single coded bitstream constituted of encoded video data in which each data item is described by means of a bitstream syntax allowing to recognize and decode all the elements of the content of said bitstream, said content being described in terms of separate channels, said device being further characterized in that it also comprises means for introducing into said coded bistream specific information indicating at a high description level in this coded bitstream the presence, or not, of various additional channels that can be encountered to describe the content of said bitstream.

The invention also relates to a transmittable video signal consisting of a coded bitstream generated by an encoding method applied to a sequence corresponding to successive scenes subdivided into successive video object planes (VOPs), said coded bitstream, generated for coding all the video objects of said scenes, being constituted of encoded video data in which each data item is described by means of a bitstream syntax allowing to recognize and decode all the elements of the content of said bitstream, said content being described in terms of separate channels, said signal being further characterized in that said coded bitstream also comprises specific information indicating at a high description level in this coded bitstream the presence, or not, of various additional channels that can be encountered to describe the content of said bitstream.

The invention finally relates to a device for receiving and decoding a video signal consisting of a coded bitstream generated by an encoding method applied to a video sequence corresponding to successive scenes subdivided into successive video object planes (VOPs), said coded bitstream, generated for coding all the video objects of said scenes, being constituted of encoded video data in which each data item is described by means of a bitstream syntax allowing to recognize and decode all the elements of the content of said bitstream, said content being described in terms of separate channels, said coded bitstream moreover comprising specific information indicating at a high description level in this coded bitstream the presence, or not, of various additional channels that can be encountered to describe the content of said bitstream.

The invention will now be described in a more detailed manner, with reference to the accompanying drawing in which:

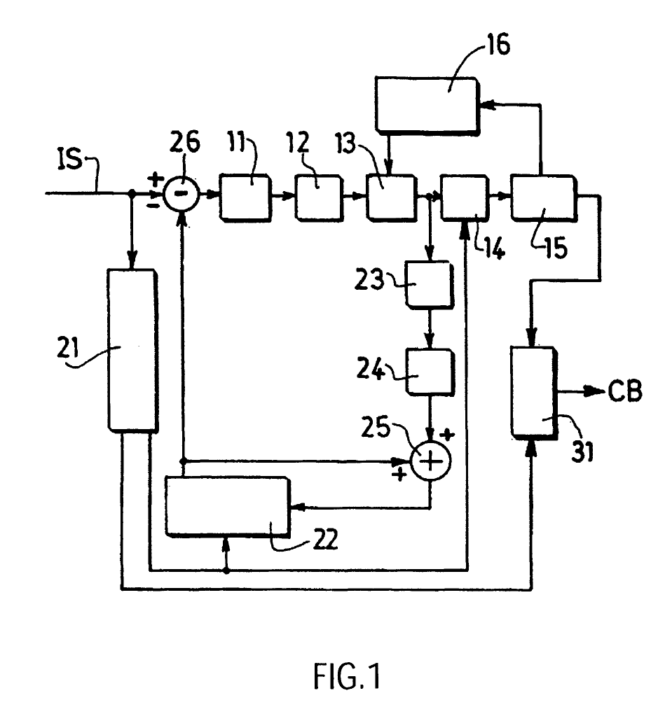

FIG. 1 shows an example of an MPEG encoding device in which the encoding method according to the invention can be implemented.

To solve the problem of waste of bits explained above, it is proposed, according to the invention, to introduce into the coded bitstream an indication about the possible presence of additional channels. This indication consists of a specific information introduced, according to the invention, at a high description level at least equivalent to the Video Object Layer (VOL) MPEG-4 level.

This additional descriptive step is implemented for example as now indicated. The following syntactic elements are defined:

| | |
|---|---|
| (a) “video_object_layer_shape”: | 1 bit |
| (b) “number_of_video_object_layer_additional_channel_{—} | n bits |
| descriptions”: | |
| (c) “video_object_layer_additional_channel [i]: | 1 bit |

and the semantic meaning of these elements is:
(a) video_object_layer_shape: this 1-bit flag indicates the presence of a shape (or contour) channel (if set to one, the contour channel is present and should be decoded, while no description of shape or contour is expected if it is not);
(b) number_of_video_object_layer_additional_channel_descriptions: this n-bit unsigned integer represents the number of additional channel syntax elements present in the coded bitstream;
(c) additional_channel_number: this integer takes values comprised between 0 and number_of_video_object_layer_additional_channel_descriptions;
(d) video_object_layer_additional_channel [additional_channel_number]: this 1-bit flag identifies the presence or not of the channel addressed by the value [i] of additional_channel_number.

The correspondences between video_object_layer_additional_channel [additional_channel_number] and the semantic of the related channel are given in the following table, for values 1 to 2ⁿ of number_of_video_object_layer_additional_channel_descriptions, called NAC in the table (n=4 in the given example):

| Additional_{—} | | | |
|---|---|---|---|
| channel_number | Semantic | No. of bits | NAC |
| 0 | video_object_layer_lum | 1 | 1 |
| 1 | video_object_layer_transparency | 1 | 2 |
| 2 | video_object_layer_disparity | 1 | 3 |
| 3 | video_object_layer_texture | 1 | 4 |
| 4 | video_object_layer_depth | 1 | 5 |
| 5 | user_defined | 1 | 6 |
| 6 | user_defined | 1 | 7 |
| 7 | user_defined | 1 | 8 |
| 8 | user_defined | 1 | 9 |
| 9 | user_defined | 1 | 10 |
| 10 | user_defined | 1 | 11 |
| 11 | user_defined | 1 | 12 |
| 12 | user_defined | 1 | 13 |
| 13 | user_defined | 1 | 14 |
| 14 | user_defined | 1 | 15 |
| . . . | user_defined | 1 | . . . |

The proposition according to the invention leads therefore to a modified version of the syntax for Video_object_layer. In page 36 of the document w3056, the following syntactic elements are added (lines 15 and following):

| | | |
|---|---|---|
| video_object_layer_shape | 1 | Uimsbf |
| if (video_object_layer_verid > 2) { | | |
| number_of_video_object_layer_additional_channel_{—} | n | Uimsbf |
| descriptions | | |
| for (j=0 ; j< number_of_video_object_layer_additional_{—} | | |
| channel_descriptions, j++) | | |
| Video_object_layer_additional_channels[j] | 1 | uimsbf |
| } | | |

Examples of implementation (channel presence description+corresponding syntax) for various types of objects may be given, the syntax element which indicates the presence of chrominance channels being decoded only if the presence of a luminance channel has been indicated in the bitstream:

| (a) a coloured 4:2:2 rectangular sequence: | |
|---|---|
| video_object_layer_shape: | 0 |
| number_of_video_object_layer_additional_channel_descriptions: | 1 |
| video_object_layer_lum: | 1 |
| video_object_layer_chrom: | 1 |
| (b) a black-and-white scene with an opaque object | |
| having a contour but no texture: | |
| video_object_layer_shape: | 1 |
| number_of_video_object_layer_additional_channel_descriptions: | 0 |
| (c) a 4:2:2 black-and-white object having an | |
| opaque shape (or contour): | |
| video_object_layer_shape: | 1 |
| number_of_video_object_layer_additional_channel_descriptions: | 1 |
| video_object_layer_lum: | 1 |
| video_object_layer_chrom: | 0 |
| (d) a coloured 4:2:2 rectangular object | |
| having a transparent alpha plane: | |
| video_object_layer_shape: | 0 |
| number_of_video_object_layer_additional_channel_descriptions: | 2 |
| video_object_layer_lum: | 1 |
| video_object_layer_chrom: | 1 |
| video_object_layer_transparency: | 1 |
| (e) a 4:2:2 rectangular object with its depth: | |
| video_object_layer_shape: | 0 |
| number_of_video_object_layer_additional_channel_descriptions: | 5 |
| video_object_layer_lum: | 1 |
| video_object_layer_chrom: | 1 |
| video_object_layer_transparency | 0 |
| video_object_layer_disparity | 0 |
| video_object_layer_texture | 0 |
| video_object_layer_depth | 1 |

The two following alternative syntaxes may also be proposed:

| | | |
|---|---|---|
| video_object_layer_shape | 1 | Uimsbf |
| if (video_object_layer_verid > 2) { | | |
| number_of_video_object_layer_additional_channel_presence | n | Uimsbf |
| j = 0; | | |
| k = 0; | | |
| While | | |
| (j<number_of_video_object_layer_additional_channel_descriptions) | | |
| { | | |
| j = j + video_object_layer_additional_channels[k]; | 1 | Uimsbf |
| k = k + 1; | | |
| } | | |
| } | | |
| Video_object_layer_shape | 1 | uimsbf |
| if (video_object_layer_verid > 2) { | | |
| Number_of_video_object_layer_additional_channel_descriptions = 2ⁿ; | | |
| for (j=0 ; | | |
| j<number_of_video_object_layer_additional_channel_descriptions, | | |
| j++) | | |
| Video_object_layer_additional_channels[j] | 1 | uimsbf |
| } | | |

The video encoding method described above may be for instance implemented in an encoding device such as for instance the one illustrated in FIG. 1 showing an example of an MPEG encoder with motion compensated interframe prediction. This encoder comprises coding and prediction stages. The coding stage itself comprises in series a mode decision circuit 11 (for determining the selection of a coding mode I, P or B as defined in MPEG), a DCT circuit 12, a quantization circuit 13, a variable-length coding circuit 14 and a buffer 15, a rate control circuit 16 provided in a feedback connection allowing to control the quantization step size of the quantization circuit 13. The prediction stage comprises a motion estimation circuit 21 followed by a motion compensation circuit 22, and also, in series, an inverse quantization circuit 23, an inverse DCT circuit 24 and an adder 25, a subtractor 26 allowing to send towards the coding stage the difference between the input signal IS of the coding device and the predicted signal available at the output of the prediction stage (i.e. at the output of the motion compensation circuit 22). This difference, or residual, is the bitstream that is coded. The motion vectors determined by the motion estimation circuit 21 are sent towards a multiplexer 31, together with the output signal of the buffer 15, in order to be multiplexed in the form of an output coded bitstream CB at the output of the multiplexer. Said bitstream CB is the coded bitstream that, according to the invention, will include specific information indicating the presence, or not, in said coded bitstream, of the various additional channels that can be encountered to describe the content of the bitstream.

The invention also relates to a transmittable video signal consisting of a coded bitstream generated by such a video encoding device.

Reciprocally, according to a corresponding decoding method, the additional syntactic elements, transmitted to the decoding side within the coded bitstream, are read by appropriate means in a video decoder receiving them and carrying out said decoding method. The decoder, which is able to recognize and decode all the segments of the content of the coded bitstream, reads said additional syntactic elements and knows that one or several additional channels are then present or not present. Such a decoder may be of any MPEG-type, as the encoding device, and its essential elements are for instance, in series, an input buffer receiving the coded bitstream, a VLC decoder, an inverse quantizing circuit and an inverse DCT circuit. Both in the coding and decoding device, a controller is provided for managing the steps of the coding or decoding operations.

The foregoing description of the preferred embodiments of the invention has been presented for purposes of illustration and description. It is not intended to be exhaustive or to limit the invention to the precise forms disclosed, and obviously modifications and variations, apparent to a person skilled in the art and intended to be included within the scope of this invention, are possible in light of the above teachings.

It may for example be understood that the coding and decoding devices described herein can be implemented in hardware, software, or a combination of hardware and software, without excluding that a single item of hardware or software can carry out several functions or that an assembly of items of hardware and software or both carry out a single function. The described method and devices may be implemented by any type of computer system or other adapted apparatus. A typical combination of hardware and software could be a general-purpose computer system with a computer program that, when loaded and executed, controls the computer system such that it carries out the method described herein. Alternatively, a specific use computer, containing specialized hardware for carrying out one or more of the functional tasks of the invention could be utilized.

The present invention can also be embedded in a computer program product, which comprises all the features enabling the implementation of the method and functions described herein and—when loaded in a computer system—is able to carry out these method and functions. Computer program, software program, program, program product, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

1. An encoding method applied to a video sequence corresponding to successive scenes subdivided into successive video object planes (VOPs) and generating, for coding all the video objects of said scenes, a coded bitstream constituted of encoded video data in which each data item is described by means of a bitstream syntax allowing to recognize and decode all the elements of the content of said bitstream, said content being described in terms of separate channels, said method being further characterized in that said syntax comprises specific information indicating at a high description level in said coded bitstream the presence, or not, of various additional channels that can be encountered to describe the content of said bitstream.

2. A method according to claim 1, in which said specific information consists of the following additional syntactic elements:
video_object_layer_shape: 1 bit
number_of_video_object_layer_additional_channel_descriptions: n bits
video_object_layer_additional_channels [i]: 1 bit
the first element indicating the presence, or not, of a contour or shape channel that should then be decoded, the second one representing the number of additional channel syntax elements present in the coded bitstream in order to describe the content of said bitstream, and the third one identifying the presence, or not, of the channel addressed by the value [i], i taking a value between 0 and 2ⁿ−1.

3. A method according to claim 1, in which said specific information consists of the following additional syntactic elements:
video_object_layer_shape: 1 bit
number_of_video_object_layer_additional_channel_presence: n bits
video_object_layer_additional_channels [i] 1 bit
the first element indicating the presence, or not, of a contour or shape channel that should then be decoded, the second one representing the number of additional channels present in the coded bitstream, and the third one identifying the presence, or not, of the channel addressed by the value [i], i taking a value between 0 and 2ⁿ−1.

4. A method according to claim 1, in which said specific information consists of the following additional syntactic elements:
video_object_layer_shape: 1 bit
video_object_layer_additional_channels [i] 1 bit, 0<=i<=2ⁿ−1
the first element indicating the presence, or not, of a contour or shape channel that should then be decoded, and the second one identifying the presence, or not, of the channel addressed by the value [i], i taking a value between 0 and 2ⁿ−1.

5. A method according to claim 2, characterized in that the video_object_layer_shape syntactic element is not provided in the bitstream.

6. A device for encoding a video sequence corresponding to successive scenes subdivided into successive video object planes (VOPs), said device comprising means for structuring each scene of said sequence as a composition of video objects (VOs), means for coding the shape, the motion and the texture of each of said VOs, and means for multiplexing the coded elementary streams thus obtained into a single coded bitstream constituted of encoded video data in which each data item is described by means of a bitstream syntax allowing to recognize and decode all the elements of the content of said bitstream, said content being described in terms of separate channels, said device being further characterized in that it also comprises means for introducing into said coded bistream specific information indicating at a high description level in said coded bitstream the presence, or not, of various additional channels that can be encountered to describe the content of said bitstream.

7. A transmittable video signal consisting of a coded bitstream generated by an encoding method applied to a video sequence corresponding to successive scenes subdivided into successive video object planes (VOPs), said coded bitstream, generated for coding all the video objects of said scenes, being constituted of encoded video data in which each data item is described by means of a bitstream syntax allowing to recognize and decode all the elements of the content of said bitstream, said content being described in terms of separate channels, said signal being further characterized in that said coded bitstream also comprises specific information indicating at a high description level in said coded bitstream the presence, or not, of various additional channels that can be encountered to describe the content of said bitstream.

8. A device for receiving and decoding a video signal consisting of a coded bitstream generated by an encoding method applied to a video sequence corresponding to successive scenes subdivided into successive video object planes (VOPs), said coded bitstream, generated for coding all the video objects of said scenes, being constituted of encoded video data in which each data item is described by means of a bitstream syntax allowing to recognize and decode all the elements of the content of said bitstream, said content being described in terms of separate channels, said coded bitstream moreover comprising specific information indicating at a high description level in said coded bitstream the presence, or not, of various additional channels that can be encountered to describe the content of said bitstream.
